(19) United States
(12) Patent Application Publication
(10) Pub. No.: US 2014/0278324 A1
(43) Pub. Date: Sep. 18, 2014

(54) Interactive Tissue Model for Simulating the Electrical Activity of Excitable Tissues

(71) Applicant: Visible Electrophysiology, LLC., Colchester, VT (US)

(72) Inventors: Oliver Richard John Bates, Montreal QC (CA); Peter Salem Spector, Colchester, VT (US)

(73) Assignee: VISIBLE ELECTROPHYSIOLOGY, LLC., Colchester, VT (US)

(21) Appl. No.: 14/216,620

(22) Filed: Mar. 17, 2014

Related U.S. Application Data
(60) Provisional application No. 61/801,900, filed on Mar. 15, 2013.

(51) Int. Cl. G06F 19/00

(52) U.S. Cl. CPC G06F 19/3437
USPC 703/11

(57) ABSTRACT

A method of simulating electrical propagation in the heart muscle on a computing device having a processor and a memory includes providing a structural representation of a heart muscle. The structural representation includes a plurality of tissue elements. The plurality of tissue elements have a shape corresponding to shape of a heart muscle. The method includes storing a model of electric potential propagation through the structural representation in the memory. The model includes a piecewise linear equation describing electrical activity within each tissue element and a difference equation describing conduction from one of the tissue elements to an adjacent tissue element. The method also includes providing a first set of tunable parameters for inclusion in the piecewise linear equation and a second tunable parameter for inclusion in the difference equation. The method further includes tuning the first set of tunable parameters and the second tunable parameter in the model. The method also includes running said model on the processor of the computing device and displaying the simulated electrical propagation through the heart muscle over time.

### FIELD

This patent application generally relates to a programmable computer system that simulates electrical activity in excitable tissue. More particularly, it relates to a system that simulates electrical activity in a heart muscle.

### RELATED PAPERS

The following three papers are incorporated herein by reference:
1. Spector, P. S., and “Cardiac Electrical Propagation and its Implications for Reentrant Arrhythmias”, submitted for publication in Circ Arrhythm Electrophysiol, 2013.
2. Spector, P. S., Habel, N., Sobel, B. E., Bates, J. H. T, “Emergence of Complex Behavior An Interactive Model of Cardiac Excitation Provides a Powerful Tool for Understanding Electric Propagation”, Circ Arrhythm Electrophysiol, August 2011.
3. Spector, P. S., Correa de Sa, D. D., Tischler, E. S., Thompson, N. C., Habel, N., Stinnett-Donnelly, J., Benson, B. E., Bielau, P., Bates, J. H. T, “Ablation of Multi-Wavelet Re-entry: General Principles and in Silico Analyses”, Europace (2012) 14, v106-v111.

### BACKGROUND

The spread of electric excitation through the intricate 3D structure of the heart muscle has been known to take widely varied forms, ranging from the orderly propagation seen during sinus rhythm to the marked disorganization seen during ventricular fibrillation. Observation of the diverse and sometimes complex patterns of conduction (for example, unidirectional block, reentry, spiral waves) as well as the responses to pacing maneuvers (for example, entrainment) suggests a nearly infinite array of possibilities.

Improved systems for simulating the electrical behavior of excitable tissues have been needed. Such systems may be used to deepen understanding of how electrical signals propagating through the heart muscle are related to arrhythmia and other heart conditions. Such systems may also lead to improvements in detection and correction of arrhythmias and other conditions. Such an improved system is provided by the following description.

### SUMMARY

One aspect of the present patent application is a method of simulating electrical propagation in a heart muscle on a computing device having a processor and a memory. The method includes providing a structural representation of a heart muscle. The structural representation includes a plurality of tissue elements. The plurality of tissue elements have a shape corresponding to shape of a heart muscle. The method includes storing a model of electric potential propagation through the structural representation in the memory. The model includes a piecewise linear equation describing electrical activity within each tissue element and a difference equation describing conduction from one of the tissue elements to an adjacent tissue element. The method also includes providing a first set of tunable parameters for inclusion in the piecewise linear equation and a second tunable parameter for inclusion in the difference equation. The method further includes tuning the first set of tunable parameters and the second tunable parameter in the model. The method also includes running said model on the processor of the computing device and displaying the simulated electrical propagation through the heart muscle over time.

Another aspect is a method of simulating electrical propagation in the heart muscle on a computing device having a processor and a memory. The method includes storing a model of electric potential propagation through a heart muscle in the memory. The method further includes running the model on the processor. The method further includes displaying simulated electrical propagation through the heart muscle produced by running said model on the processor, wherein said simulated electrical propagation is displayed in a time approximately equal to actual propagation time in a real heart muscle.

### BRIEF DESCRIPTION OF THE DRAWINGS

The foregoing will be apparent from the following detailed description, as illustrated in the accompanying drawings, in which:

FIG. 1a is a three dimensional representation of the human heart derived from human CT scan data in which the heart is divided into tissue elements;

FIG. 1b is a screen shot showing a modeling program offering a user choice for of selecting custom modeling parameters or selecting from a previously saved model;

FIG. 1c is a cutaway view of the 3D heart model showing electrical currents flowing through the excitable tissue structures and illustrating how the user can slice through the 3D heart model to view electrical activity spreading through the excitable tissue;

FIG. 2 is a screen shot from a flat tissue model with electrodes recording at a user controlled location relative to the tissue with electrograms (EGMs) displayed at the right and showing a colored wavefront that moved through the flat sheet of tissue, in which each specific color represents tissue elements that are at the same potential (isopotential map) and excitation is traveling from the left to the right in a flat sheet of tissue being modeled and the wave front of excitation is colored with each color corresponding to the potential of a tissue element, and tissue elements with the same potential will have the same color (iso-potential map) wherein electrodes in the model are placed at a user-defined location above the tissue and their respective recordings, i.e. unipolar electrograms are displayed in real time in the tracing window on the right;

FIG. 3 is a screen shot from a 3D heart model with a point electrode placed at a user defined location relative to the tissue;

FIG. 4 is a screen shot from a 3D heart model with an electrode at the tip of a catheter placed at a user controlled location relative to the tissue;

FIG. 5 is a screen shot from a 3D heart model showing stimulation of the tissue initiated from an electrode located at the tip of a catheter placed at a user-controlled location relative to the tissue and in which one can see the wave front of electrical activation emanating from that location with the area surrounding the electrode not active because the screen capture occurred after the elements surrounding the electrode had been stimulated;

FIG. 6 is a screen shot from a planar tissue model showing two bipolar catheters arranged at arbitrary angles to the tissue with EGMs displayed on the right representing the potential difference between the two electrodes located on each (bipolar) catheter, in which deflections in the bipolar electrograms (1^{st} and 4^{th} from the top) result from the orientation of these catheters relative to the propagating wavefront, wherein a flat sheet of tissue is shown with excitation spreading from the left to the right, and the two catheters, each with a tip and a ring electrode, are placed perpendicular to each other, and the unipolar and bipolar electrograms recorded from those locations are displayed on the right, and while a unipolar electrogram is derived from a single electrode in contact with the tissue (index electrode) in reference to an electrode that is far from the recording region of the index electrode, the bipolar electrogram is derived from the difference between the signals recorded from two electrodes (tip and ring electrode on a catheter) in contact with the tissue;

FIG. 7 is a screen shot from the 3D heart model with multiple electrodes and multiple catheters, in which the cutaway reveals electrodes inside the chambers, while others sit outside the chambers in particular veins, and EGMs are plotted as a function of time on the right hand side of the screen, and each catheter has a user-specified number of electrodes, catheters can be placed on the endocardial surface (inside the chamber) or on the epicardial surface (outside the chamber) or within the coronary sinus, and electrograms are recorded real-time;

FIG. 8 is a screen shot showing ablation of tissue from the electrode at the tip of a catheter in which the user controls the location of the catheter and specifies which catheter and electrode will be used to ablate tissue and in which ablation alters the electrical properties of the tissue elements in such a way that excitable tissue becomes injured and eventually electrically disconnected from the surrounding tissue elements;

FIG. 9 is a functional block diagram of the digital communication interface of the interactive model of the present patent application for simulating electrical activity of excitable tissues and communication to other (third party) systems;

FIG. 10a is a screen shot of contiguous wavefronts identified at a particular time step of simulation;

FIG. 10b is a screen shot of a wave “family-tree” in which each node corresponds to a specific wave in a specific time step and lines are drawn between nodes with a strong spatial correlation;

FIG. 11 is a screen shot displaying the user interface for the fully functional stimulator that enables the user to perform programmed stimulation protocols, similar to what would be seen in a clinical environment;

FIG. 12 is a screen shot of the display simulating an “X-Ray” view, which is the only visual modality seen in real clinical settings;

FIG. 13 is a screen shot of a 3-point electro-anatomic map collected in a flat two-dimensional tissue using a roving electrode and a reference electrode;

FIG. 14 is a screen shot of the real isochronal map calculated from the simulated propagation through the tissue showing the theoretical solution to the sample map displayed in FIG. 13;

FIG. 15 is a screen shot of the user configurable panel to set up groups of excitable tissue elements within the model as well as modify the parameter values of each individual tissue element;

FIG. 16 is a screen shot of the user programmable interface to specify the tissue elements' shape, dimensions, and boundary types, as well as the number of elements which comprise a custom tissue, and the user may then use the property editor shown in FIG. 15 to assign values to each tissue element parameter;

FIG. 17 is a screen shot of the user configurable interface for specifying electrode type, dimensions, and location within the model in which types of electrodes include a point electrode, or finite element model of arbitrary height, radius, area, and a cap (as opposed to a hollow cylinder), and the properties settings allow the user to specify filtering (Tsmoothing) and the number of tissue elements that influence the output EGM for a particular catheter;

FIG. 18 is a screen shot of the user configuration window for EGMs, and within this window users can set the time over which individual EGMs shall be displayed, the user can also add tracings that represent unipolar or bipolar electrograms or the action potentials from individual tissue elements within the model, and the user can also set the gain of these EGMs, as well as the horizontal (time axis) scaling;

FIG. 19 is a screen shot demonstrating an example of how the user can interact with the EGM tracing window, in which users can move the first cursor to specific features of the EGMs, and then stretch the second cursor to another feature to measure the time that has elapsed between the first and second feature;

FIG. 20 is a flowchart depicting the algorithm for simulating propagation of electric potential using one embodiment of the model of the present patent application;

FIG. 21 is a flowchart depicting how to perform the task of updating each tissue element internally, as referred to in box 102 of FIG. 20;

FIG. 22 is a screen shot of the splash page for integrated model with didactic content in which the left hand side displays a list of content modules, while the right hand side displays a list of most recently opened parameter values for the model;

FIG. 23 is a screen shot of the integrated didactic content (text slide). The left hand panel displays the outline of the presently opened module (“EP Study Basics”) and the right hand and panel displays a specific slide within that module;

FIG. 24 is a screen shot of the integrated didactic content (video) in which the left hand panel displays the outline of the presently opened module (“EP Study Basics”) and the right hand and panel displays a video with an explanation of a particular concept;

FIG. 25 is a screen shot of the integrated didactic content (interactive quiz) in which the left hand panel displays the outline of the presently opened module (“EP Study Basics”) and the right hand and panel displays a quiz that users make take to test their knowledge. Quiz results are stored for review by a system administrator;

FIG. 26 is a screen shot of the integrated didactic content (interactive exercise using the computer model described herein) in which the bottom left hand panel provides instructions to guide the user through an interactive exercise with the model (right hand panel);

FIG. 27 is a screen shot of the fully functional interactive model operating in an independent mode where users can load preconfigured parameter values, as well as assign these values manually; and

FIG. 28 is a graphical representation of the piece-wise linear functionality of the individual tissue elements.

### DETAILED DESCRIPTION

One embodiment of the present patent application is a three dimensional model that provides for visualization of the flow of electrical potential and/or electrical current within the three dimensional structures of the heart muscle. This embodiment includes simulation of a user-definable two or three dimensional shape for the heart with its electrically excitable tissue and includes simulation of positioning electrodes, catheters, and stimulators in any arbitrary location in and around the electrically excitable tissue. This embodiment also includes simulation of the torso so that electrocardiograms obtained from surface mounted electrodes can be accurately modeled.

### Anatomic Representation of the Tissues:

In one embodiment, data collected from imaging the torso, such as computerized axial tomographic (CT) scan images, is used to create a three dimensional model representative of a specific individual's anatomy, including the heart and surrounding tissue, as shown in FIG. 1a.

For 2D models, the electrically excitable elements of the model may include shapes such as triangles or squares. For 3D shell models of uniform thickness, the electrically excitable elements of the model may also include arbitrary 2D shapes, such as triangles or squares, as shown with triangular elements in FIG. 1a which illustrates simulation of the inner shape of an actual human heart from CAT scan data.

For 3D models of structures with variable and substantial thicknesses, each electrically excitable element is represented by a 3D shape, such as cubic or tetrahedral.

A user can upload 2D and 3D models of tissues, as required for a given simulation, from a personal computer or handheld device, as shown in the screen shot of FIG. 1b, into the simulating system computer. Alternatively the 2D and 3D models of tissues may be downloaded from a server over a local area network (LAN), wide area network (WAN), or remote server connected to the internet “cloud” into the simulating system computer. Once loaded into the simulating system computer, the models can be saved locally, such as to the hard drive, and the models can run on the simulating system computer processor which may be the user's personal computer.

Once running on the simulating system computer, the tissue may be rotated for viewing on a display at any user-desired angle, and tissue may be “cut away” so that electrical activity may be viewed from within the 3D structural model of the tissue. An example of a cutaway view with electrical activity displayed is provided in the screen shot of FIG. 1c.

In one embodiment, the model includes such simplification of electrical transport mechanism in tissue elements and between adjacent tissue elements that the processor can provide for displaying electrical activity moving through the heart muscle in a time approximately equal to actual propagation time. In one embodiment, the simplification of computational steps to simulate propagation involves a linear approximation of the equation that updates the internal state of each tissue element. This vastly increases speed compared to published computational models that use more complicated functions than a linear approximation to simulate electrical propagation in cardiac tissue.

The model of electrical tissue activation may be run in real-time, slow motion, faster than real-time or stopped at any time during the simulation.

### Arbitrary Location of Electrodes and Catheters

In one embodiment, stimulating and recording electrodes in the model may be placed at any user-desired (arbitrary) location in and around the tissue. For example, for the planar modeled tissue of FIG. 2, the electrodes have been placed on the tissue as well as above the tissue at various locations. An electrode is placed on the 3D heart model at a user controlled arbitrary location in FIG. 3. A screen shot from a 3D heart model with an electrode at the tip of a catheter placed at a user-controlled location relative to the tissue is shown in FIG. 4.

### Electrical Excitation & Display of Electrical Activity

In one embodiment, the model includes a set of parameters for conduction within each tissue element and a difference parameter, such as electrical resistance, for conduction between tissue elements. Each of these parameters may be displayed in color coded fashion. In one embodiment, as tissue is stimulated by a virtual electrical input from an electrode, a colored wave front moves through the tissue simulation over time. In this embodiment, each specific color represents a specific voltage level. Thus, the display demonstrates all the tissue elements that are at the same time voltage at the same time (i.e. representative of isopotential activation).

A screen shot from a 3D heart model showing stimulation of the tissue initiated from an electrode located at the tip of a catheter placed at a user-controlled location relative to the tissue is shown in FIG. 5. The wave front of common potential from the electrical activation can be seen emanating from that electrode location. The area surrounding the electrode is not active in this figure because the screen capture occurred after the elements surrounding the electrode had been stimulated.

A screen shot of two simulated catheters located at a ninety degree angle to one another on electrically excitable planar tissue is shown in FIG. 6. An electrode is located at each catheter tip. The electrograms (EGMs) displayed in FIG. 6 are representative of the difference in potential between the two electrodes.

A screen shot from the 3D heart model with multiple electrodes and multiple catheters is shown in FIG. 7. The electrograms are representative of electrical potentials as calculated by the model corresponding to any user-selected electrode. Electrodes may serve as either recording devices (providing EGMs for display over time) or as stimulating devices (providing electrical signals to the model to initiate activation of the tissues being modeled).

### Ablation of Electrically Excitable Tissue

In one embodiment, the model simulates ablation of tissue, removing excitability of a tissue element and/or electrically disconnecting one or more tissue elements from neighboring tissue elements. This is equivalent to setting the “aliveness” property to false. The model enables a user to observe the flow of electrical activity through the tissue before and after ablation and to observe how ablation of a particular region affects the relative timing of deflections recorded in an EGM, tissue activation times, and relative amplitudes of electrical activity.

A screen shot showing ablation of tissue from the tip of a catheter is shown in FIG. 8. The model enables a user to control the location of the catheter and to specify which catheter and which electrode will be used to ablate the tissue.

### Science Tools

One application of the model provided in the present patent application is to enable understanding of complex heart muscle reentrant rhythms that may be aperiodic or that manifest as complex sequences of wave collisions and wave breaks. Ultimately, any arrhythmia due to such reentry of electrical excitation will involve the continuous propagation of at least a single wave of excitation, though it may split off into daughter waves or collide with other waves in the process. Before the present patent application, identifying the pathways of these reentrant waves was a near impossible task for the human eye.

One embodiment of the present patent application provides a method for tracking excitation waves through time in two steps. First, contiguous waves are identified in sequential frames (time steps). A sample frame with identified contiguous wave fronts is shown in FIG. 10a. Second, waves are directionally correlated with waves from the previous and following frames in order to build parent/daughter relationships. These relationships result in a wave “family tree” structure, as shown in FIG. 10b. This technique allows a user to identify the entire genesis of a particular wave of excitation at any moment in time.

### Batch Tool

In one embodiment, the model provides a batching capability that allows a user to run many simulations in parallel or in series with no additional input from the user once the first process is initiated. In this embodiment, each simulation can record user specified data to a local or network storage resource for further data observation or manipulation.

### Clinical Tools

In one embodiment real clinical environments are simulated in the model. In one embodiment, an X-Ray view is produced in the simulation, as shown for a planar tissue in FIG. 12. The X-ray view simulates a real X-ray, which is the only real imaging modality available to an electrophysiologist during a procedure in a clinical setting.

In another embodiment, electroanatomic mapping is simulated in the model. In this embodiment, a user may specify a reference electrode and a roving electrode. The relative timing between signals from these electrodes is used along with the location of the roving electrode to build an isochronal map of tissue activation. A 3 point sample of an isochronal map on a planar tissue is shown in FIG. 13.

In another embodiment a real isochronal map is calculated based on the simulation produced by the model when given specific parameter values. This allows a user to compare the accuracy of the map produced manually using the roving electrode to the theoretical solution. The real isochronal map is calculated and displayed in FIG. 14 for the same tissue model produced by the simulation in FIG. 13.

### Stimulator

In one embodiment a fully functional stimulator is included in the simulator, as shown in FIG. 11. The fully functional stimulator allows a user to visually see how published clinical pacing maneuvers work and to practice performing them in a simulated environment. In one embodiment, a user may specify preprogrammed stimulations (S1 and S2 in the figure, though additional stimulations may be added at will), triggered stimulations, or burst stimulations. For burst pacing, the user specifies a pacing site (electrode), as well as amplitude, cycle length, and number of beats. For triggered pacing, the user specifies the pacing site (electrode), the trigger electrode (along with its threshold value), the amplitude, and coupling interval.

### Interfacing to Physical Catheters and Catheter Simulation Systems

In one embodiment, a user controls the location of electrodes and catheters by moving a computer input device, such as a trackpad or mouse. This allows simulations to run on personal computers and other devices that are controlled through user gestures.

In another embodiment, a digital interface is included that allows third party systems to read data simulated by the model of electrically excitable tissues. A module is included that formats output of the simulation so that it can be input to a third party device that normally takes data coming from a real heart.

Magnetic tracking devices designed for tracking the location of catheters within the body are currently in production by Ascension Technology Corporation of Milton, Vermont. These trackers use small orthogonal coils located on the catheter to report the incident EM wave signals. The signals are produced by a stationary or wearable EM field source. From the coil data, the orientation and position of the catheter relative to the source may be calculated. Provided that the location of the source with respect to the tissue is known, the location of the catheter relative to the tissue is also known. These data can be input to our model of electrical activity of the tissue.

Thus, a user may move an actual catheter (as opposed to a computer input device, such as a trackpad or mouse) inside a simulated subject and simulated heart. Once inside the simulated physical representation of the heart, the location data would be sent to the model. The present model can then be run by the user on a computer as if the catheter were located in an actual subject. Thus, a user uses the model to experience replicating all the conditions that would be encountered in a clinical setting.

In another embodiment, the virtual position of the catheter in the present simulation is determined based on integrating data from a commercially available haptic control of the catheter—as if a physical catheter were present within a physical body (herein referred to as a haptic interpretation unit). Such a commercially available haptic control simulator is currently available under the trade name ANGIO Mentor^{a} by Simbionix USA of Cleveland, Ohio and Simbionix Ltd of Airport City, Israel. These haptic control simulators can provide a visual simulation of the 3D heart tissue, with views that represent ultrasound visualization as well as fluoroscopy visualization. The haptic control simulators do not provide any information on the electrical activity of the simulated tissue, and thus are of limited utility for electrophysiology training and education.

In one embodiment, the present electrical model of excitable tissue includes an open architecture interface that supports third party catheter manufacturers as well as firms that produce simulations of the physical properties of catheters and tissues. In one embodiment the model includes a digital communications protocol that these third parties may use to provide instruction to the simulation. A hard wired Ethernet (TCP/IP) digital interface is shown, however, other serial interfaces could be accommodated, including serial (USB, RS-232, RS-485, RS-422) and wireless Ethernet (802.11), Bluetooth (802.15), or Zigbee (802.15.4) and others.

In this embodiment, the third party provides the position and orientation data of the catheter or electrodes relative to the heart over the digital interface. A separate, dedicated personal computer or dedicated microprocessor is used to run the electrical simulation of the tissue using the position and orientation data of the catheter or electrodes relative to the heart provided from the third party and to support user controlled functions such as the display of EGMs.

A functional block diagram showing how the third party systems would interface to the present model of electrically excitable tissues of the present patent application is shown in FIG. 9.

### Interfacing to EGM Recording Systems

In one embodiment, the electrical model of excitable tissue of the present application includes an open architecture interface to support third party electrophysiologic, electroanatomic or anatomic imaging system manufacturers (for example, x-ray systems, electrogram recording systems, ultrasound systems and 3D electroanatomic recording systems). In this embodiment, electrical and anatomic/location data is exported from the present model over a digital communications port. In one use, a trainee can view electro-anatomic data without requiring the use of living, electrically excitable tissue or “canned” prerecorded EGM data. Users can control their own experience and learn by moving the catheters and electrodes as they would in the clinical setting. The users can decide where to place electrodes and catheters, decide on a course of action, and ablate the tissue, all within the model of the present patent application, then see the result of their training session on a third party's display.

### Open Architecture Digital Communications Protocols

Input Protocol: In one embodiment, catheter electrode position and orientation are input via Transmission Control Protocol (TCP) and Internet Protocol (IP). Third party software which transmits digital data to the specified host address and in the appropriate formats may modify the position and orientation of specific catheter electrodes within the Visible EP software environment at run-time. Tables 1 and 2 contain the packet formats and their respective functions. All multi-byte values are entered in little-endian format. Floating point values follow the IEEE Standard for Float-Point Arithmetic (IEEE 754) for single-precision floating point representations.

TABLE 1
Data packet for modifying the position of a catheter electrode:

| | | Electrode | | | | |
|---|---|---|---|---|---|---|
| Data | Header | ID | x | y | z | Trailer |
| Size | 2 bytes | 1 byte | 4 bytes | 4 bytes | 4 bytes | 2 bytes |
| For- | 0xCA01 | Unsigned | IEEE 754 | IEEE 754 | IEEE 754 | 0x01CA |
| mat | | Short | Single- | Single- | Single- | |
| | | | Precision | Precision | Precision | |

In one embodiment, the model of the present patent application moves the electrode identified by the specified ID to the location defined by {x, y, z} in its coordinate space. This implies that the third party system supplying this information has knowledge of the model's coordinate system beforehand.

TABLE 2
Data packet for modifying the orientation of a catheter electrode:

| | | Electrode | | | | |
|---|---|---|---|---|---|---|
| Data | Header | ID | x | y | z | Trailer |
| Size | 2 bytes | 1 byte | 4 bytes | 4 bytes | 4 bytes | 2 bytes |
| For- | 0xCA02 | Unsigned | IEEE 754 | IEEE 754 | IEEE 754 | 0x02CA |
| mat | | Short | Single- | Single- | Single- | |
| | | | Precision | Precision | Precision | |

In one embodiment, the electrode identified by the specified ID is oriented such that the catheter shaft leading away from it will do so in the direction defined by {Nx, Ny, Nz} in its coordinate space. This implies that the third party system supplying this information has knowledge of the model's coordinate system beforehand, though the scale of the {Nx, Ny, Nz} vector is irrelevant.

These orientation data can also be provided as an orientation matrix or a quaternion, in the case where axial rotation of a catheter is relevant.

Output Protocol: In one embodiment, data is output from the simulation in order to emulate data coming from a real patient in a clinical environment. This is performed by a modular translation unit that converts the data stored internally by the model simulation to the appropriate format for the specific third party system connected for receiving this data. In this case, a customized translation unit is developed or provided for the particular third party system.

### User Configurable Model Parameters

In one embodiment, software configurable panels provide the users with capability to change values of key operational parameters, as shown in screen shots in FIGS. 15, 16, 17, and 18. FIG. 15 provides the user configurable panel (or “window”) used to set up the model's excitable elements, referred to as “cells” or “tissue elements.” In the provisional patent application from which this patent application claims priority, we used the word “cell” to describe both biologic cells as well as the simulated tissue elements. To avoid ambiguity, in the present application we are continuing to use “cell” to refer to biologic cells and use the term “tissue element” to refer to the computational cells (units) into which a model tissue is broken up, as shown in FIG. 1a. The tunable electrical parameters of the tissue elements are defined under “property editor” in FIG. 15. Groups of tissue elements may be defined by the user. In the embodiment of FIG. 15 groups that are important for the anatomic structure of the human heart, such as the right and left atriums, right and left ventricles, the sinus node and AV node, fast and slow pathways, and the His-Purkinje system are all pre-defined in the simulation.

The user programmable tissue creation window shown in FIG. 16 allows the user to specify tissue element shape, dimensions, and boundary types, as well as the number of elements which comprise a custom tissue. The user may then use the property editor shown in FIG. 15 to assign values to each tissue element parameter.

FIG. 17 provides the user configurable interface (window) for specifying electrode type, dimensions, and location within the model. Types of electrodes include a point electrode, or finite element model of arbitrary height, radius, area, and a cap (as opposed to a hollow cylinder). The properties settings allow the user to specify filtering (Tsmoothing) and the number of tissue elements that influence the output EGM for a particular catheter.

FIG. 18 provides the user configuration interface (window) for EGMs. Within this window users can set the time over which individual EGMs shall be displayed. The user can also add tracings that represent unipolar or bipolar electrograms or the action potentials from individual tissue elements within the model. The user can also set the gain of these EGMs as well as the horizontal (time axis) scaling.

FIG. 19 provides an example of how the user can interact with the EGM tracing window. Users can move the first cursor to specific features of the EGMs, and then stretch the second cursor to another feature to measure the time that has elapsed between the first and second feature.

Each tissue element's state is defined by two variables, potential (or voltage) and phase. In the model, tissue elements of the heart can be in one of several different phases, including Rest, Upstroke, Plateau, Repolarization, and Relative Refractory, as shown in Table 3. Phase is what determines which part of the piece-wise linear function an element is operating in. The behavior of a tissue elements potential in the various phases is shown in FIG. 28.

TABLE 3
Tissue element phases
Tissue Element Phases

| | | | | |
|---|---|---|---|---|
| Rest | Upstroke | Plateau | Repolarization | Relative Refractory |

In the model, tissue elements of the heart also have tunable values of each of parameters, including the following parameters, as shown in Table 4: activation threshold, activation rate, plateau potential, plateau time, repolarization rate, resting potential, restitution slope, restitution factor, minimum activation slope, minimum plateau time, maximum repolarization rate, aliveness, type of element (pacemaker), spontaneous depolarization rate, and leak potential. For aliveness and type of element (pacemaker) the values are Boolean--true or false.

TABLE 4
Tissue element parameters

| Parameter Name | Variable Representation |
|---|---|
| Activation Threshold | Vth |
| Activation Rate | dVup |
| Plateau Potential | Vplateau |
| Plateau Time | Tplateau |
| Repolarization Rate | dVrepolarization |
| Resting Potential | Vrest |
| Restitution Slope | Rslope |
| Restitution Factor | Rfactor |
| Minimum Activation Slope | dVupmin |
| Minimum Plateau Time | Tplateaumin |
| Maximum Repolarization Rate | dVrepolarizationmax |
| Element state (“Alive” or “Dead”) | Alive (true or false) |
| Element type (“Regular” or “Pacemaker”) | Pacemaker (true or false) |
| Spontaneous Depolarization Rate | dVdepol |
| Leak Potential | dVleak |

In performing the simulation the processor running the model starts, as shown in box 100 by first updating each tissue element potential by diffusion, such as via Ohm's law, as shown in box 101 of FIG. 20. In the simulation, the diffusion step is performed as shown in Table 5.

TABLE 5
Pseudo-code of diffusion step in simulation algorithm

```
  For each element i:
    For each element j connected to i by a coupling strength of value Rij:
      Update electric potentials of elements i (Vi) and j (Vj) in three steps:
      1-Calculate the diffused quantity: dV = (Vj − Vi) / Rij
      2-Update potential of i: Vi = Vi + dV
      3-Update potential of j: Vj = Vj − dV
```

The processor then updates each tissue element internally, as shown in box 102 of FIG. 20. The processor then determines whether the simulation is still running, as shown in box 103. If so the processor returns to update box 101. If not, the processor stops, as shown in box 104.

For calculations within each tissue element the processor follows a process as illustrated in FIG. 21, starting in box 110. The processor starts with the first element, as shown in box 111 and determines whether that element is alive, as shown in box 112. If not, the processor determines whether this is the last element, as shown in box 113. If so it is done, as shown in box 114. If not, the processor gets the next element, as shown in box 115 and continues to do so until it finds an element that is alive, as shown in box 112.

When the processor finds an element that is alive, the processor checks whether the phase is Rest, as shown in box 116. If so, the processor then determines whether the element is a pacemaker, as shown in box 117. If so, the processor sets the new voltage to be equal to the old voltage plus an increment for depolarization, as shown in box 118. The processor then checks whether the voltage is greater or equal to a threshold, as shown in box 119. If so, the processor changes the phase to upstroke, as shown in box 120 and in FIG. 28. So long as the element in question is in Rest phase, and its voltage is below the threshold, it remains in Rest phase. Only when the element's voltage exceeds the threshold, as a result of diffusion or as a result of spontaneous depolarization in the case of pacemaker elements, will the element phase change to Upstroke. The threshold is one of the tunable parameters as shown in table 4.

If the processor finds that the phase is not Rest in box 116, the processor then determines whether the phase is Upstroke, as shown in box 121. If so, the processor sets the new voltage to be equal to the old voltage plus an increment for upstroke, as shown in box 122. The processor then checks whether the voltage is greater or equal to the plateau voltage, as shown in box 123. If so, the processor changes the phase to plateau, as shown in box 124.

If the processor finds that the phase is not upstroke in box 121, the processor then determines whether the phase is Plateau, as shown in box 125. If so, the processor sets the new voltage to be equal to Vplateau, as shown in box 126. The processor then checks whether a time equal to Tplateau has elapsed, as shown in box 127. If so, the processor changes the phase to repolarization, as shown in box 128.

If the processor finds that the phase is not Plateau in box 125, the processor then determines whether the phase is Repolarization, as shown in box 128. If so, the processor sets the new voltage to be equal to the old voltage plus an increment for repolarization, as shown in box 129. The processor then checks whether the voltage is greater or equal to a threshold, as shown in box 130. If so, the processor changes the phase to relative refractory, as shown in box 131.

If the processor finds that the phase is not Repolarization in box 128, the processor then determines whether the phase is relative refractory, as shown in box 132. If so, the processor sets the new voltage to be equal to the old voltage minus an amount for repolarization, as shown in box 133. The processor then checks whether the voltage is less than or equal to Vrest, as shown in box 134. If so, the processor changes the phase to rest, as shown in box 135. The processor then checks whether the voltage is greater than or equal to a threshold, as shown in box 136. If so, the processor applies restitution (see table 6) and sets the phase to Upstroke, as shown in box 137.

The step after each of the above checks whether this is the last element, and if so ends processing. If not the processor gets the next element and the process starts again.

TABLE 6
Pseudo-code for updating a tissue element's
parameter values according to restitution

First calculate:
dVupNew = minimum of (dVup) & (maximum of [dVupmin] &
[dVupmin+Vtrough/Vth])
TplateauNew = maximum of (Tplateaumin) & (Tplateau-DI*Rslope)
dVrepolarizationNew = maximum of (dVrepolarizationmax) &
(dVrepolarization+DI*Rslope)
Then update parameters:
dVup = Rfactor * dVupNew + (1-Rfactor)dVup
Tplateau = Rfactor * TplateauNew + (1-Rfactor)Tplateau
dVrepolarization = Rfactor * dVrepolarizationNew +
(1-Rfactor)dVrepolarization
where Vtrough is the minimum value of V reached during the most recent period of time during which the element phase, P, was equal to Relative Refractory; APD is the sum Tplateau + (Vplateau-Vrest)/dVrepolarization; & DI is the time since the previous change from P =Rest or P = Relative Refractory to P = Upstroke.

Upon starting the software, the user is presented with a splash page shown in FIG. 22. From here, the user may decide to open a module of didactic content from the list on the left hand side. Alternatively, the user may decide to enter the laboratory mode, on the right hand side of the panel.

In the didactic mode of the software, the user may progress through a module of educational material presented as a combination of text and image based slides (FIG. 23), videos (FIG. 24), interactive quizzes (FIG. 25) and interactive exercises using the model described herein (FIG. 26). In the latter case, instructions are provided to the user to guide them through the use of the model, while familiarizing them with the user interface for starting and stopping the simulation; modifying tissue elements properties; adding, moving, and removing catheters and electrodes; manipulating the electrogram tracing window; performing electroanatomic mapping; perform clinical pacing maneuvers; and otherwise interact with the capabilities of the model.

In the laboratory mode of the software, the user is able to load existing parameters configurations (e.g. FIG. 27) either supplied in advanced or prepared at a prior time by this or other users. The user may interact here with the full capabilities of the model, as described above. This mode enables a user to perform a full simulation of a clinical procedure in simulated X-Ray view, from diagnosis to treatment. The user may at any time “look at the answer” by choosing to display real-time electric potential of each tissue element, or by computing and displaying the real isochronal map.

Aspects of certain embodiments of the present patent application include:
1. A model of the electrical behavior of excitable tissues which supports an arbitrary tissue geometry, with user controlled catheter and electrode position and location.
2. A system which uses the model of aspect 1 to enable physical catheters to send digital data representative of catheter position to control a virtual catheter within the user interface of the model.
3. A system which uses the model of aspect 1 to enable electrical activity from the model to interface to physical electrical recording systems to drive these physical electrical recording system's displays.
4. A software interface which uses the model of aspect 1 to provide user-controlled electrode size and type (bipolar or unipolar).
5. A system of aspect 4 which allows the location and orientation of recording electrodes to be controlled by an external input signal.
6. A system of aspect 5 in which the external input is a mouse, touchpad, tracking device, or haptic interpretation unit.
7. A software interface which uses the model of aspect 1 to provide user-controlled ablation of tissue.
8. A system of aspect 7 which allows the location and orientation of ablation electrodes to be controlled by an external input signal.
9. A system of aspect 8 in which the external input is a mouse, touchpad, tracking device, or haptic interpretation unit.
10. A software interface which uses the model of aspect 1 to provide electrograms from any user specified electrode or electrodes.
11. A software interface which uses the model of aspect 1 to allow user-defined tissue properties at run-time.
12. A software interface which uses the model of aspect 1 to allow users to track and view wavefront propagation through time.
13. A software interface which uses the model of aspect 1 to allow users to define programmed stimulation protocols.
14. A software interface which uses the model of aspect 1 to allow users to build electroanatomic maps in simulated environments.
15. A software interface which uses the model of aspect 1 and the interface of aspect 14 to provide the real isochronal activation map.
16. A software interface which uses the model of aspect 1 to define groups of tissue element within a tissue for region-specific property assignment.

While several embodiments, together with modifications thereof, have been described in detail herein and illustrated in the accompanying drawings, it will be evident that various further modifications are possible without departing from the scope of the invention as defined in the appended claims. Nothing in the above specification is intended to limit the invention more narrowly than the appended claims. The examples given are intended only to be illustrative rather than exclusive.

What is claimed is:

1. A method of simulating electrical propagation in the heart on a computing device having a processor and a memory, comprising:
a. providing a structural representation of a heart muscle in the memory, wherein said structural representation includes a plurality of tissue elements, wherein said plurality of tissue elements have a shape corresponding to shape of a heart muscle;
b. storing a model of electric potential propagation through said structural representation, wherein said model includes a piecewise linear equation describing electrical activity within each tissue element and a difference equation describing conduction from one said tissue element to an adjacent tissue element;
c. providing a first set of tunable parameters for inclusion in said piecewise linear equation and a second tunable parameter for inclusion in said difference equation;
d. tuning said first set of tunable parameters and said second tunable parameter in said model;
e. running said model on the processor of the computing device; and
f. displaying said simulated electrical propagation through said tissue elements over time.

2. A method as recited in claim 1, wherein said displaying said simulated electrical propagation includes displaying at least one from the group consisting of voltage propagation and rate of change of voltage.

3. A method as recited in claim 1, wherein said simulated electrical propagation is displayed in a time approximately equal to actual propagation time in a real heart muscle.

4. A method as recited in claim 1, further comprising storing a plurality of pre-set tunings of said first set of tunable parameters and of said second tunable parameter in said memory wherein said plurality of pre-set tunings include at least one member that would display electrical propagation through a healthy heart muscle and a plurality of members that would display electrical propagation through a heart muscle that has a heart condition when the model with that member is run on the processor.

5. A method as recited in claim 4, wherein said electrical propagation includes at least one from the group consisting of atrial fibrillation, sinus rhythm, sinus tachycardia, focal and reentrant atrial tachycardias, atrial fibrillation, atrial flutter, atrio-ventricular nodal reentrant tachycardias, physiologic phenomena of the atrio-ventricular node, disease of the specialized conduction system (conduction slowing or block), pre-excitation, accessory pathway mediated tachycardias, nodo-fascicular tachycardia, junctional tachycardia, focal and reentrant ventricular tachycardias, bundle-branch reentry, tachycardias emerging from the specialized conduction system, conduction in the presence of myocardial infarction, long-QT syndrome, brugada syndrome, and conduction in the presence of atrial and ventricular fibrosis/scarring.

6. A method as recited in claim 1, wherein said first set of tunable parameters include activation threshold, activation time, plateau potential, plateau time, repolarization time, resting potential, restitution slope, restitution factor, minimum action potential duration, maximum activation time, alive (boolean, true or false) pacemaker (boolean, true or false), spontaneously depolarization rate, leak potential.

7. A method as recited in claim 1, wherein said second tunable parameter includes electrical resistance.

8. A method as recited in claim 1, wherein said model includes provision for a user providing different values of said first set of tunable parameters in different tissue elements in the heart muscle.

9. A method as recited in claim 1, wherein said model includes provision for a user providing different values of said second parameter between different tissue elements of the heart muscle.

10. A method as recited in claim 1, wherein said computing device includes at least one from the group consisting of a mobile phone, a tablet, a phablet, a laptop, a server, and a computer.

11. A method as recited in claim 1, further comprising a display for displaying said simulated electrical propagation.

12. A method as recited in claim 10, wherein said computing device includes a cloud server in communication with said display.

13. A method as recited in claim 1, wherein said model is a three dimensional model.

14. A method as recited in claim 13, wherein said three dimensional model provides a three dimensional shell of uniform thickness.

15. A method as recited in claim 13, wherein said three dimensional model provides a three dimensional representation of structures with variable thickness.

16. A method as recited in claim 13, wherein said model of the heart includes provision for adjusting shape of the heart to correspond to a specific individual's anatomy.

17. A method as recited in claim 1, wherein said model includes ability to adjust shape of said tissue elements.

18. A method as recited in claim 1, wherein said displaying includes ability for the user to rotate the heart to a desired angle and said displaying includes ability for the user to view the heart cut away so electrical activity can be viewed from within the three dimensional structural model.

19. A method as recited in claim 1, wherein said three dimensional model further includes electrodes and catheters, wherein said model permits locating said electrodes and said catheters at a user-controlled location.

20. A method as recited in claim 19, wherein said model permits said user-control through the user moving a computer input device.

21. A method as recited in claim 19, wherein said model permits said user-control through a haptic control.

22. A method as recited in claim 1, wherein said three dimensional model further includes electrodes, wherein said model provides a difference in potential between electrodes of a pair of electrodes.

23. A method as recited in claim 1, wherein said three dimensional model further includes electrodes, wherein in said model said electrodes may serve as at least one from the group consisting of recording devices and stimulating devices.

24. A method as recited in claim 1, wherein said three dimensional model further includes electrodes, wherein in said model said electrodes may ablate tissue.

25. A method as recited in claim 1, wherein said model includes ability to track waves of electrical excitation traveling through the heart muscle through time.

26. A method as recited in claim 25, wherein said tracking waves of electrical excitation traveling through the heart muscle through time includes identifying contiguous wave fronts and directionally correlating waves to build a family tree structure.

27. A method as recited in claim 1, wherein said model includes ability to automatically run a plurality of simulations in at least one from the group consisting of in parallel and in series.

28. A method as recited in claim 1, wherein said displaying said model provides an X-ray view.

29. A method as recited in claim 1, wherein said displaying said model provides display of electric potential propagation through the heart muscle with a color code.

30. A method as recited in claim 1, wherein said running said model on the processor includes running in real-time, slow motion, faster than real time or stopped at any time.

31. A method as recited in claim 1, wherein said model includes an open architecture.

32. A method as recited in claim 19, wherein said model includes a digital communications protocol for interfacing with third-parties.

33. A method of simulating electrical propagation in a heart muscle on a computing device having a processor and a memory, comprising:
a. providing a structural representation of a heart muscle in the memory, wherein said structural representation includes a plurality of tissue elements, wherein said plurality of tissue elements have a shape corresponding to shape of a heart muscle;
b. storing a model of electric potential propagation through the tissue elements;
c. running said model on the processor; and
d. displaying simulated electrical propagation through the tissue elements produced by running said model on the processor, wherein said simulated electrical propagation is displayed in a time approximately equal to actual electrical propagation time in a real heart muscle.

34. A method as recited in claim 33, wherein said model of the heart muscle includes tissue elements, wherein said model includes a piecewise linear equation describing electrical activity within each tissue element.

35. A method as recited in claim 34, wherein said model includes a difference equation to describe conduction from one tissue element to an adjacent tissue element.

36. A method as recited in claim 35, wherein said model includes a first set of tunable parameters for said electrical activity within each tissue element and a second tunable parameter for propagation from one tissue element to an adjacent tissue element, further comprising tuning said first set of tunable parameters and said second tunable parameter in said model.
